(19) United States
(12) Patent Application Publication
(10) Pub. No.: US 2007/0300147 A1
(43) Pub. Date: Dec. 27, 2007

(54) Compression of mark-up language data

(76) Inventors: Todd W. Bates, Portland, OR (US); Karl J. Krasnowsky, Portland, OR (US); Ross E. Hagglund, Hillsboro, OR (US)

Correspondence Address: LAW OFFICES OF MICHAEL DRYJA, 1474 N COOPER RD #105-248, GILBERT, AZ, 85233, US

(21) Appl. No.: 11/426,312

(22) Filed: Jun. 25, 2006

(51) Int. Cl. G06F 17/00

(52) U.S. Cl. 715/513

(57) ABSTRACT

Markup-language data, such as extensible Markup Language (XML) data, is compressed. A first node generates compressed markup-language data. The compressed markup-language data is decompressable in accordance with a first general compression scheme that is not particular to data formatted in accordance with a markup language. The compressed markup-language data is further decompressable in accordance with a second specific compression scheme that is particular to data formatted in accordance with the markup language. The first node transmits the compressed markup-language data, which is received by a second node. The second node decompresses the compressed markup-language data using the first general compression scheme or the second specific compression scheme.

### FIELD OF THE INVENTION

The present invention relates generally to data formatted in a markup language, such as extensible Markup Language (XML), and more particularly to compressing such markup-language data.

### BACKGROUND OF THE INVENTION

Formatting data in markup languages has become a popular way to format data. One common markup language is the extensible Markup Language (XML), described in detail at the Internet web site http://www.w3.org/XML/. Markup languages such as XML are a way by which what data “is” can be described, by using a series of tags. As one simplistic example, the XML data “<user name>John Roberts</user name>” specifies that the data “John Roberts” is a user name.

Markup languages are commonly used for data serialization. Data serialization is the process of transmitting data from one node, such as one computing device, to another node, such as another computing device, over some type of communicative connection between the two nodes, such as a network, in a bit-by-bit manner. Data serialization is common over the Internet, for instance, by serializing the data and transmitting it over a protocol such as the hypertext transport protocol (http).

A difficulty with employing markup languages to serialize and transmit data over a protocol like http is that data formatted in markup languages are typically quite verbose. For instance, data may be serialized in accordance with a common information model (CIM) or a web services description language (WSDL), where the data is particularly formatted in XML. CIM is a model that can use XML for describing management information, referred to as objects, that can be collected from different computing resources. WSDL is a language that can use XML for describing web services.

In both CIM and WSDL, the XML data that may be transmitted from one node to another node can measure in the tens or hundreds of megabytes. For example, XML data for a typical CIM application may require over fourteen megabytes for 10,000 objects. In many situations, more than 60,000 objects may be needed, which means that more than 800 megabytes of XML data has to be transmitted from one node to another node. Even for relatively fast network connections, transmitting such a large amount of data can take an undesirably long time.

Therefore, markup-language data can be compressed before it is transmitted from one node to another node. Two types of compression schemes are typically used. The first type of compression scheme is a general compression technique that can be employed for all types of data, and that is not particular to markup-language data such as data formatted in XML. Common general compression techniques can be based on the LZ77 compression approach, and include the techniques known as deflate and zip. General compression schemes are useful because they are widely deployed, and therefore to some extent it can be guaranteed that if a transmitting node compresses data using such a scheme, a given receiving node is likely able to decompress the data.

However, such general compression schemes are disadvantageous because they typically require high processor utilization, decreasing performance, and also do not compress the data as much as is possible than if such schemes were instead constructed for a particular type of data. Furthermore, generating compressed data using a general compression scheme entails first creating the “raw,” uncompressed data completely, and then compressing this data. That is, there is no way to generate the compressed data “on the fly,” without having to first generate or employ raw, uncompressed data. This limitation also contributes to performance degradation.

The second type of compression scheme is a specific compression technique that can only be used for data formatted in a particular way, such as data that has been formatted in a particular markup language, such as XML. Common XML-specific compression techniques include XMill, described in detail at the Internet web site http://sourceforge.net/projects/xmill, as well as XBIS, described in detail at the Internet web site http://xbis.sourceforge.net/. Within such XML-specific compression techniques, the nature of the XML-formatted data itself is known and taken advantage of to typically compress the data more than if a general compression scheme were used.

A primary advantage of such specific compression schemes is that they are able to generate compressed markup-language data “on the fly,” without having to first completely generate or employ raw, uncompressed markup-language data. That is, the markup-language data can be “written out” in the compressed format directly, without first having to generate uncompressed markup-language data and then compressing that uncompressed markup-language data into compressed markup-language data. As such, performance is improved as compared to general compression schemes that require the raw, uncompressed markup-language data to first be initially generated in totality.

However, a significant disadvantage of such specific compression schemes is that their universality is limited, and it cannot be guaranteed to any sufficient degree that a given receiving node, such as a client, will be able to decompress the compressed markup-language data. That is, in general, there is a lack of support among clients for specific compression schemes like XMill and XBIS. As such, if a server, or other transmitting or sending node, transmits compressed markup-language data that has to be decompressed in accordance with such a specific compression scheme, the receiving node may not be able to decompress and hence use the data.

### SUMMARY OF THE INVENTION

The present invention relates to the compression of markup-language data, such as eXtensible Markup Language (XML) data. A first node generates compressed markup-language data. The compressed markup-language data is decompressable in accordance with a first general compression scheme that is not particular to data formatted in accordance with a markup language. The compressed markup-language data is further decompressable in accordance with a second specific compression scheme that is particular to data formatted in accordance with the markup language. The first node transmits the compressed markup-language data, which is received by a second node. The second node decompresses the compressed markup-language data using the first general compression scheme or the second specific compression scheme.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system depicting a node transmitting compressed markup-language data to another node, where the data is decompressable in accordance with either of two different compression schemes, according to an embodiment of the invention.

FIGS. 2A and 2B are diagrams of sample extensible Markup Language (XML) data and the sample XML data as converted to Simple Application Programming Interface (API) for XML (SAX) events, respectively, according to an embodiment of the invention.

FIGS. 3A, 3B, and 3C are diagrams depicting how a compressed markup-language document, using a SAX event representation, is divided into windows, compressed on a window-by-window basis, and transmitted, respectively, according to an embodiment of the invention.

FIGS. 4A and 4B are diagrams depicting a general compression scheme and a specific compression scheme, respectively, as to the decompression of a compressed markup-language document within a SAX event representation, according to an embodiment of the invention.

FIG. 5 is a flowchart of a method in which compressed markup-language data is generated and that can be decompressed using a general compression scheme or a specific compression scheme, according to an embodiment of the invention.

FIGS. 6A and 6B are diagrams of representative implementations of a transmitting node and a receiving node, respectively, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview and Advantages

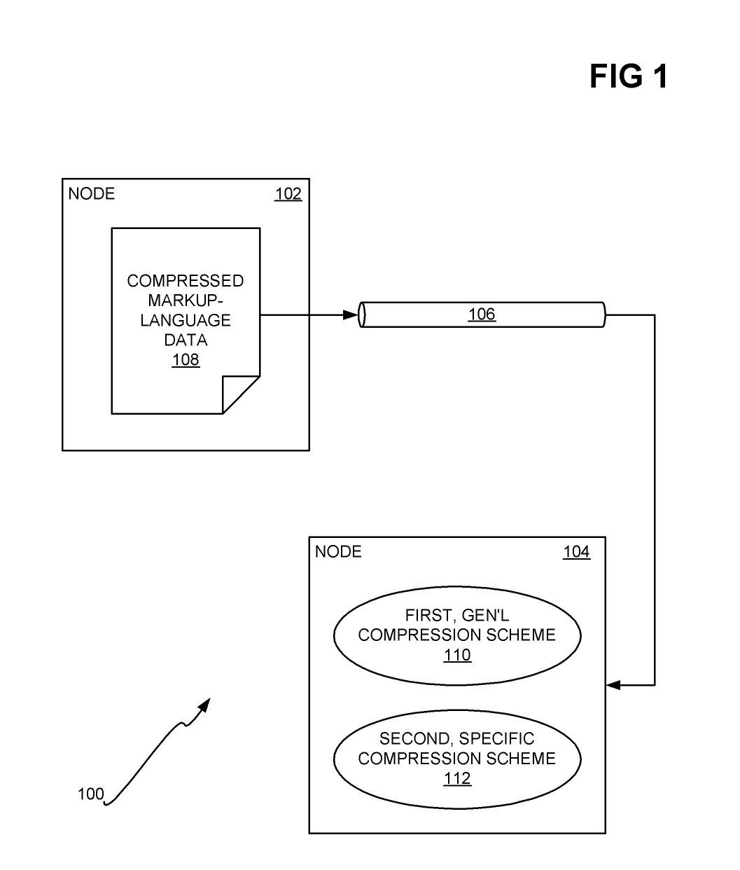

FIG. 1 shows a system 100, according to an embodiment of the invention. The system 100 includes two nodes 102 and 104 that are communicatively connected to one another, such as via a network 106. Each of the nodes 102 and 104 may be a computing device, such as a computer. The network 106 may include or be a wired network and/or a wireless network, among other types of networks.

The node 102 generates compressed markup-language data 108. The compressed markup-language data 108 may be compressed eXtensible Markup Language (XML) data in one embodiment. The node 102 may generate or “write out” the compressed markup-language data 108 directly, or “on the fly,” without first having to generate raw, uncompressed markup-language data and then compressing such raw, uncompressed markup-language data to yield the compressed markup-language data 108. Alternatively, the node 102 may first generate or employ the uncompressed markup-language data and compress this uncompressed data to yield the compressed data 108.

The node 102 transmits the compressed markup-language data 108 to the node 104 over the network 106. The node 102 may serialize the compressed markup-language data 108, such that the data 108 is substantially transmitted on a bit-by-bit basis over the network 106 to the node 104 as the node 102 generates the data 108. That is, the node 102 may not have to first completely generate the compressed markup-language data 108 before it begins transmitting the data 108 to the node 104 over the network 106. The node 102 may transmit the compressed markup-language data 108 over a given transport protocol, such as the hypertext transport protocol (HTTP) as known within the art.

Upon receiving the compressed markup-language data 108, the node 104 decompresses the data 108 in accordance with one of two schemes. The first scheme is a general compression scheme 110 that is not particular to data that is formatted in accordance with the markup language. By comparison, the second scheme is a specific compression scheme 112 that is particular to data formatted in accordance with the markup language. Therefore, it can be said that the compressed markup-language data 108 is decompressable in accordance with the first general compression scheme 110, or the second specific compression scheme 112.

The first general compression scheme 110 may be a widely available and installed compression scheme, such that it can be substantially guaranteed to at least some degree that nodes like the node 104 will be able to decompress data in accordance with the scheme 110. An example of such a general compression scheme 110 is an LZ77 compression approach, including the techniques known as deflate and zip. Therefore, the node 102 generates the compressed markup-language data 108 such that the compressed markup-language data is decompressable using the general compression scheme 110 is advantageous, because the node 102 can be substantially certain that the node 104 has the general compression scheme 110, and thus is able to decompress the data 108.

The second specific compression scheme 112, by comparison, is particular to data being formatted in accordance with a particular markup language, such as XML. The specific compression scheme 112 takes advantage of properties of markup language-formatted data in order to provide for faster compression and decompression. An example of such a specific compression scheme 112 that provides for decompression of compressed markup-language data that is nevertheless also decompressable using a general compression scheme 110 is described in detail in the next section of the detailed description.

The second specific compression scheme 112 may not be as widely available and as widely installed a compression scheme as the first general compression scheme 110 is. Therefore, it cannot be substantially guaranteed that nodes like the node 104 will be able to decompress data in accordance with the scheme 112. However, because the compressed markup-language data 108 is decompressable using either the scheme 110 or the scheme 112, this does not matter. A node, such as the node 104, preferably decompresses the compressed markup-language data 108 in accordance with the specific compression scheme 112. However, if the scheme 112 is not installed at or available to the node, then the node can instead use the general compression scheme 110 to decompress the data 108.

Therefore, generating the compressed markup-language data 108 so that it is decompressable in accordance with a first general compression scheme 110 and a second specific compression scheme 112 is advantageous, because it balances two competing goals. The goal of highest-performance decompression that comes only with the knowledge that the compressed data is markup-language data is achieved by having the data 108 be decompressable with the specific compression scheme 112. The goal of substantially guaranteed decompression is achieved by having the data 108 be decompressable with the general compression scheme 110.

Therefore, if the node 104 has the second specific compression scheme 112 available, as is the case in the example of FIG. 1, then the node 104 will decompress the compressed markup-language data 108 using the scheme 112. Only if the node 104 does not have the specific compression scheme 112 available will the node 104 decompress the compressed markup-language data 108 using the scheme 110. From the perspective of the node 102, however, it can be substantially guaranteed that the node 102 will be able to decompress the generated compressed markup-language data 108, by desirably using the scheme 112 if available, and if not, by alternatively using the scheme 110.

Furthermore, while the node 102 may be able to generate the compressed markup-language data 108 directly and “on the fly,” the node 104 may only be able to decompress the data 108 directly and “on the fly” by using the specific compression scheme 112, and not by using the general compression scheme 110. That is, when using the specific compression scheme 112 to decompress the data 108, the node 104 may be able to decompress and use the data 108 as it is received, and not have to wait for the data 108 to be completely received before decompressing and utilizing it. By comparison, when using the general compression scheme 110 to decompress the data 108, the node 104 may alternatively have to wait until the data 108 has been received in its entirety before beginning decompression, and then may have to completely decompress the data 108 before utilizing the data.

The advantages associated with the node 102 in generating the compressed markup-language data 108 that can be decompressed using both the first general compression scheme 110 and the second specific compression scheme 112 are at least two-fold. First, as has been noted, the node 102 can be relatively sure that a receiving node, such as the node 104, will be able to decompress the data 108, since the general compression scheme 110 is likely to be available to the node 104. Second, because the node 102 may be able to generate the compressed markup-language data 108 directly and transmit it over the network 106 as the data 108 is being generated, performance benefits accrue. This is as compared to having to first generate raw, uncompressed markup-language data and/or waiting for such raw data to be completely generated before compressing it in the compressed data 108.

The advantages associated with the node 104 in decompressing the compressed markup-language data 108 are also at least two-fold. First, as has been noted, the node 104 is likely to be guaranteed to be able to decompress the data 108, since even if it does not have the specific compression scheme 112 available, it is likely to have to general compression scheme 110 available, and thus able to decompress the data 108. Second, where the node 104 does have the scheme 112 available for decompressing the data 108, it may be able to decompress and use the data 108 directly and “on the fly” to achieve performance benefits. That is, the node 104 may not have to first decompress the data 108 into raw, uncompressed mark-up language data and/or wait for the data 108 to be completely received before decompressing and/or using the data 108.

### Technical Details

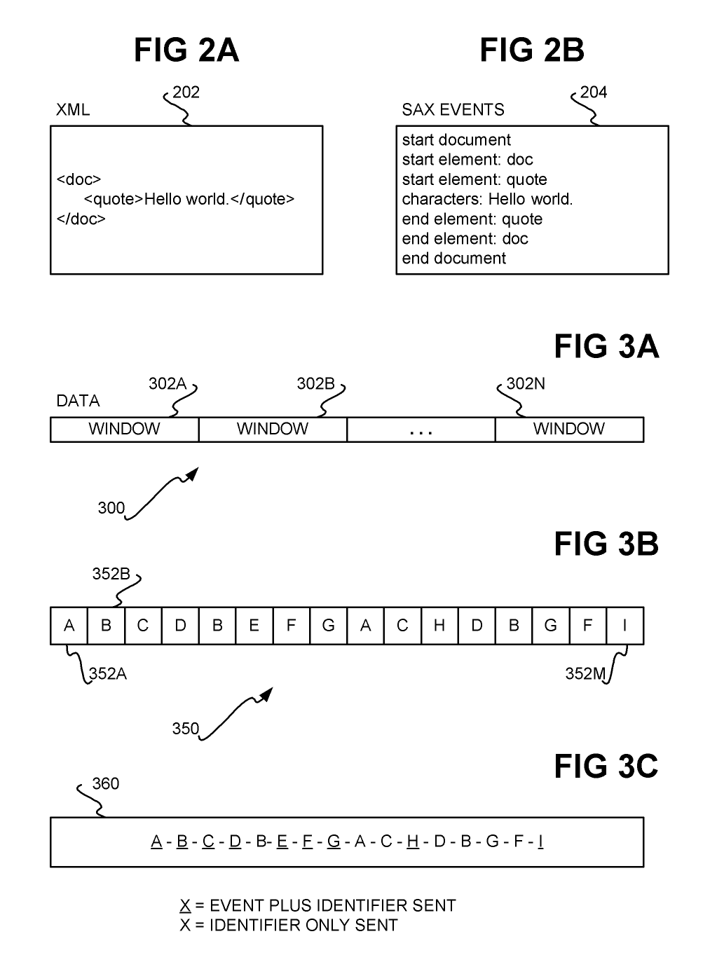

FIG. 2A shows a simple example of markup-language data 202, according to an embodiment of the invention. The markup-language data 202 is specifically XML data. The XML data 202 is depicted in FIG. 2A in a raw, uncompressed form, in accordance with regular XML representation, as can be appreciated by those of ordinary skill within the art. The XML data 202 is considered a document, by virtue of the tags <doc> and </doc>. Within this document is a single quote, specified by the surrounding tags <quote> and </quote>. This single quote is the data “Hello world.” Therefore the XML formatting of the data “Hello world.” specifies that this data is a quote within a document.

FIG. 2B shows the simple example of the markup-language data 202 of FIG. 2A after translation into Simple Application Programming Interface (API) for XML (SAX) events, according to an embodiment of the invention. SAX is an event-driven model for processing and representing XML data, and is described in detail at the Internet web site http://www.saxproject.org/. Whereas most XML processing models, such as the Document Object Model (DOM) and XML Path (XPath), employ an internally constructed tree representation of XML data, SAX instead uses an event-based representation of the XML data. The most common type of SAX event is the DocumentHandler event, examples of which are now discussed in relation to the markup-language data 202.

The SAX-event representation 204 in FIG. 2B of the XML data 202 of FIG. 2A includes all the DocumentHandler events associated with the XML data 202. Other types of events, such as ErorrHandler events, are not described herein, as they are not needed for purposes of at least some embodiments of the invention. The SAX-event representation 204 starts with an event “start document” and ends with the event “end document,” to denote that the XML data 202 has begun to be processed, and that the data 202 has been completely processed, respectively.

Upon encountering the tag <doc>, the SAX event “start element: doc” is provided within the SAX-event representation 204. The next tag <quote> is translated as the SAX event “start element: quote,” and then the characters of the actual data of the XML data 202 of FIG. 2A are translated as the SAX event “characters: Hello world.” Thereafter, the tag </quote> is translated as the SAX event “end element: quote,” and the tag “</doc> is translated as the SAX event “end element: doc.”

The XML data 202 of FIG. 2A is represented on a text character-by-text character basis, such as in ASCII text format. Thus, the tag “<doc>” is represented by five characters: “<“, “d”, “o”, “c”, and “>“. Such text character representation of XML contributes to its verbosity. By comparison, the SAX-event representation 204 of FIG. 2B is not represented in a text character-by-text character basis. For instance, the SAX event “start: element: doc” may be represented by as little as one character. Thus, the SAX-event representation 204 by itself is a compression of the XML data 202.

FIGS. 3A, 3B, and 3C show how a SAX-event representation of XML data can be further compressed, according to an embodiment of the invention. In FIG. 3A, the SAX-event representation 300 has been divided into a number of data windows 302A, 302B, . . . 302N, collectively referred to as the data windows 302. The number and length of each of the data windows 302 may be determined by the particular compression scheme being employed. Each of the data windows 302 contains one or more of the events of the SAX-event representation of the XML data.

In FIG. 3B, a representative data window 350 is depicted as including SAX events 352A, 352B, . . . , 352M, collectively referred to as the SAX events 352. Each different SAX event is identified by a different letter. Some SAX events repeat themselves within the data window 350. In the example of FIG. 3B, there are nine different SAX events, lettered A through I, but there is a total of sixteen SAX events. The SAX event represented by the letter A is repeated twice, for instance, within the data window 350. By comparison, the SAX event represented by the letter B is repeated three times, and the SAX event represented by the letter C is repeated twice, as are the SAX events represented by the letters D, F, and G. The SAX events represented by the letters E, H, and I are each found just once within the data window 350.

In FIG. 3C, an example of a compressed data stream 360 corresponding to the data window 350 of FIG. 3B is depicted, showing how the data window 350 may be compressed for transmission from one node to another node. When a particular SAX event is first encountered within the data window 350, both the event itself and an identifier representing the event are sent within the data stream 360, although the event may be subject to initial compression before transmission. Such SAX event instances are denoted within the data stream 360 by underlining. When a particular SAX event is next encountered within the data window 350, after its initial encounter, only the identifier for the SAX event is sent within the data stream 360, and the complete SAX event is not sent within the data stream 360. The process described in relation to FIG. 3C is repeated for each of the data windows 302 of the SAX-event representation 300 of FIG. 3A.

Thus, when a receiving node receives the data stream 360, when it first encounters a particular SAX event, and receives the identifier associated with this event, it may decompress and cache the SAX event to its original, uncompressed form, and associate the received identifier with the SAX event as provided within the data stream 360. The next time a particular SAX event is encountered, after its initial encounter, the identifier associated with the SAX event is simply replaced with the complete, uncompressed form of that SAX event, as has been previously decompressed, cached, and associated with the identifier. Where this process is performed for each of the data windows 302 of the SAX-event representation 300 of FIG. 3A, the SAX-event representation 300 can be completely constructed by the receiving node. The functionality that has been described in relation to FIG. 3C can be considered as the process that is performed to compress the SAX-event representation 300 in one embodiment.

The compression of the SAX events of the SAX-event representation 300 can therefore be achieved by using a standard compression scheme, such as an LZ77 compression approach, including the techniques known as deflate and zip. Thus, the SAX-event representation 300 is treated as standard text data, and compressed by a standard compression scheme. As such, the general compression scheme 110 can be employed to decompress the compressed SAX events, and the resulting decompressed SAX events parsed on a SAX event-by-SAX event basis into a regular XML representation of the data. However, this two-process approach—decompression followed by parsing on a SAX event-by-SAX event basis—is not the quickest approach, although it can be employed even where just the compression scheme 110 is available.

However, where the specific compression/decompression scheme 112 is available, then both of these processes are combined into one process, and thus are performed more quickly. Furthermore, parsing is performed just the first time a given SAX event is encountered in one embodiment, since the specific compression scheme 110 leverages its knowledge that the compressed data represents compressed SAX events. Therefore, when a given SAX event is encountered the second time, parsing is technically not performed. Rather, the previously parsed SAX event (into regular XML representation) is used again, and this also speeds decompression. The compressed SAX events are thus directly uncompressed and parsed (the latter just once per unique SAX event in one embodiment) in a single-process approach into a regular XML representation of the data.

Therefore, by using a standard compression scheme to compress the SAX events of the SAX-event representation 300, the general compression scheme 110 can be employed to decompress the SAX events, and the resulting SAX events are then parsed into a regular XML representation of the data, in a two-process approach. However, the specific compression scheme 112 can desirably be used when available, and leverages knowledge that the compressed data is compressed SAX events, so that decompression and parsing—the latter which is achieved just once per unique SAX event in one embodiment—occur at the same time, speeding the decompression process.

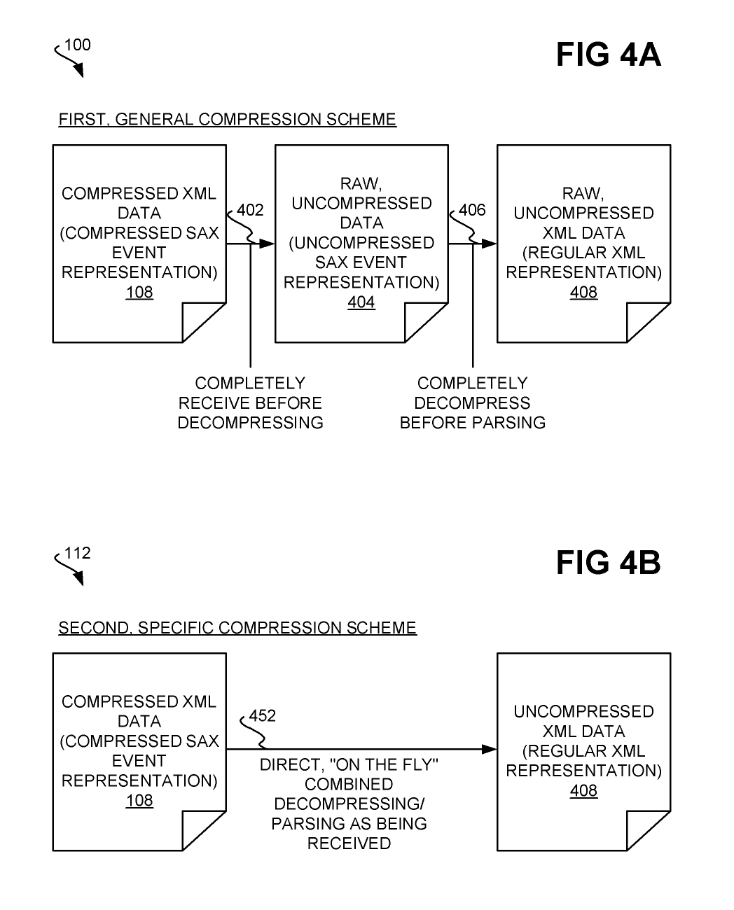

As such, FIGS. 4A and 4B show how the first general compression scheme 110 of FIG. 1 and the second specific compression scheme 112 of FIG. 1, respectively, differ in their decompression of the compressed markup-language data 108, according to varying embodiments of the invention. In both FIGS. 4A and 4B, the compressed markup-language data 108 is a compressed SAX-event representation of raw, uncompressed XML data in regular XML representation. That is, the data 108 includes a number of compressed windows, such as the example data stream 360 that has been depicted in and described in relation to FIG. 3C. By comparison, the raw, uncompressed XML data in regular XML representation is such as the XML data 202 that has been depicted in and described in relation to FIG. 2A.

In FIG. 4A, the approach employed in conjunction with the general compression scheme 110 to decompress and use the raw, uncompressed XML data in regular XML representation from the compressed XML data 108 is depicted. The process starts with the compressed XML data 108, which is a compressed SAX-event representation, as has been described. This compressed XML data 108 is completely received by a receiving node before it is decompressed, as indicated by the arrow 402, as opposed to being decompressed “on the fly” as the data 108 is received in a bit-by-bit or a byte-by-byte manner.

Upon decompression, raw, uncompressed XML data 404 results. However, the raw, uncompressed XML data 404 is still a SAX-event representation, and not a regular XML representation. That is, the decompression performed by the general compression scheme for each data window takes a data stream, such as the data stream 360 of FIG. 3C, and returns a corresponding uncompressed data window, such as the data window 350 of FIG. 3B. Upon so decompressing all the data windows, the result is an uncompressed SAX-event representation, such as the SAX-event representation 204 of FIG. 2B.

The general compression scheme 110, in other words, cannot further parse, or translate, the SAX-event representation back into regular XML representation, such as the XML data 202 of FIG. 2A, because it has no knowledge of the type of data that the compressed XML data 108 is. Rather, it can perform just a general decompression of the compressed XML data 108, to result in the raw, uncompressed XML data 404 that is still in SAX-event representation. Thereafter, the raw, uncompressed XML data 408 in regular representation, an example of which is the XML data 202 of FIG. 2A, is obtained only after the compression scheme 110 has completely decompressed the compressed XML data 108 into the uncompressed XML data 404 in SAX-event representation, as indicated by the arrow 406.

Thus, once the compressed XML data 108 has been completely decompressed into the uncompressed XML data 404 in SAX-event representation by using the general compression scheme 110 at a receiving node, the receiving node can then subsequently parse the SAX-event representation of the XML data 404 back into the regular XML representation of the XML data 408, using a SAX parsing tool.

It is noted that the utilization of the general compression scheme 110 in FIG. 4A is particularly depicted in this figure as parsing the raw, uncompressed XML data 404 in SAX-event representation into the raw, uncompressed XML data 408 in regular XML representation. However, the raw, uncompressed XML data 404 may be parsed, or otherwise employed, in a different way. For instance, rather than parsing the raw, uncompressed XML data 404 in SAX-event representation into the raw, uncompressed XML data 408 in regular XML representation, it may instead be directly parsed and used without first having to generate the raw, uncompressed XML data 408 in regular XML representation.

That is, the disadvantage with the general compression scheme 110 as outlined in FIG. 4A is that the general compression scheme 110 has no knowledge and does not take advantage of the fact that the compressed XML data 108 is indeed compressed markup-language data, and particularly is in a compressed SAX-event representation. Rather, the general compression scheme 110 can only decompress the compressed XML data 108 in the compressed SAX-event representation to raw, uncompressed XML data 404 in an uncompressed SAX-event representation. The scheme 110 cannot perform any further actions on, such as parsing or other utilization of, the uncompressed XML data 404. Decompression thus is performed on the compressed XML data 108 as a whole in a first process, and then subsequent parsing or other utilization of the uncompressed XML data 404 is performed in a separate process apart from the scheme 110.

Next, in FIG. 4B, the approach employed in conjunction with the specific compression scheme 112 to decompress and use the raw, uncompressed XML data in regular XML representation from the compressed XML data 108 is depicted. The process starts with the compressed XML data 108, which is a compressed SAX-event representation, as has been described. As the compressed XML data 108 is received—i.e., “on the fly”—it is directly decompressed and parsed into the uncompressed XML data 408 in the regular XML representation, via the specific compression scheme 112 itself, as indicated by the arrow 452.

That is, the specific compression scheme 112, based on its knowledge and taking advantage of the compressed data 108 being compressed XML data 108 in SAX event representation, is able to decompress the compressed data 108 and parse the resulting decompressed data into the uncompressed XML data 408 in regular XML representation in a single process, as the data 108 is received. For example, consider the case where the XML data 108 includes the data stream 360 of FIG. 3C. The specific compression scheme 112 receives the compressed SAX event A. Upon receiving the compressed SAX event A, it decompresses this to yield the decompressed SAX event A corresponding to the event 352A of FIG. 3B. Such a decompressed SAX event may have the form of one of the DocumentHandler events depicted in FIG. 2B, for instance. The decompressed SAX event can then be immediately translated into a corresponding regular XML representation, such as is depicted in FIG. 2A, even before the compressed SAX event B within the data stream 360 has been received or likewise processed.

As another example, later within the data stream 360 of FIG. 3C, the identifier for the SAX event A may be receiver, as indicated by A′. Decompression of this SAX event yields replacing the cached whole SAX event A for this identifier, yielding another one of the DocumentHandler events such as is depicted in FIG. 2B, for instance. This decompressed SAX event can also be immediately translated into a corresponding regular XML representation, such as is depicted in FIG. 2A, even before the next compressed SAX event or the next SAX event identifier has been received or likewise processed.

The specific compression scheme 112, therefore, further parses, or translates, the SAX-event representation back into a regular XML representation, at the same time that it decompresses the SAX-event representation from the compressed XML data 108. The scheme 112 can perform such processing or translation because it has knowledge of the type of data that the compressed XML data 108 is. There is no need to generate raw uncompressed XML data in an uncompressed SAX-event representation, as in FIG. 4A.

Decompression and parsing are thus performed as a single process when the specific compression scheme 112 is employed, and can further be performed “on the fly” as the compressed XML data 108 is received, on a bit-by-bit or a byte-byte basis, for instance. Once a given compressed SAX event or SAX event identifier has been received and decompressed, the scheme 112 can immediately parse or otherwise use the uncompressed SAX event. Whereas the general scheme 110 in FIG. 4A cannot perform such parsing or other utilization, the specific scheme 112 in FIG. 4B can, as part of the same process in which decompression is achieved.

Similar to FIG. 4A, it is noted that the utilization of the specific compression scheme 112 in FIG. 4B is particularly depicted as decompressing and parsing the compressed XML data 108 in compressed SAX-event representation into the raw, uncompressed XML data 408 in regular XML representation. However, compressed XML data 108 may be decompressed and parsed, or otherwise employed, in a different way. For instance, rather than being parsed into the raw, uncompressed XML data 408 in regular XML representation, it may instead be directly parsed and used without generating the raw, uncompressed XML data 408 in regular XML representation.

### Method, Representative Nodes and Conclusion

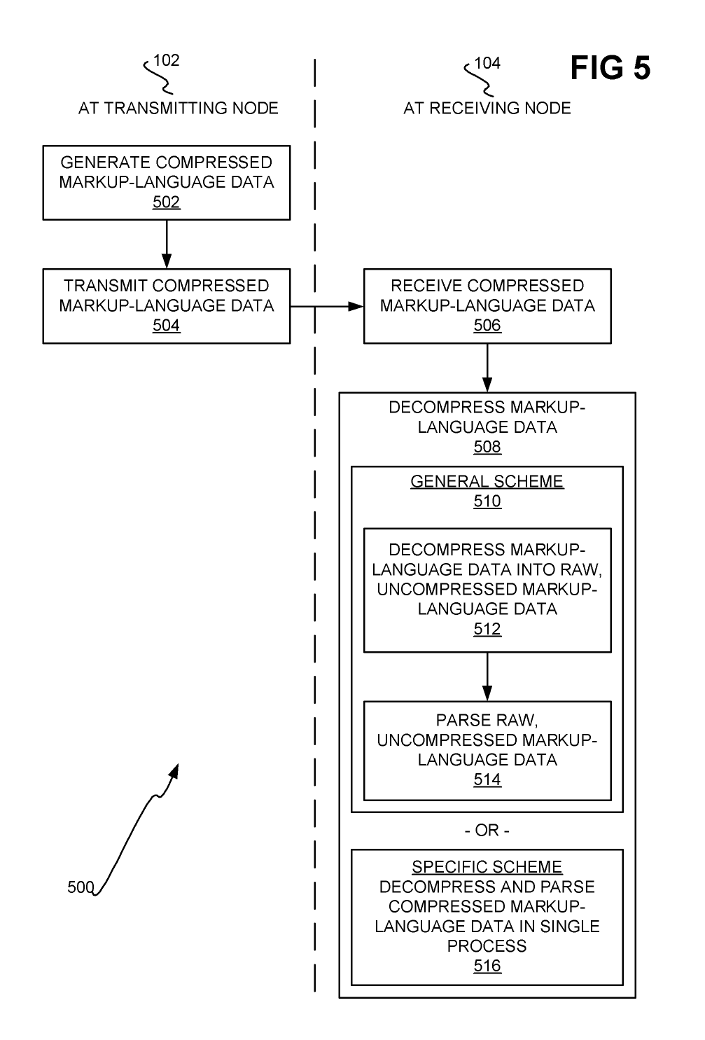

FIG. 5 shows a method 500, according to an embodiment of the invention. The parts of the method 500 to the left of the dotted line in FIG. 5 are performed by a transmitting node, such as the node 102 of FIG. 1. By comparison, the parts of the method 500 to the right of the dotted line in FIG. 5 are performed by a receiving node, such as the node 104 of FIG. 1.

The node 102 generates compressed markup-language data 108 (502), as has been described. The compressed data 108 is decompressable in accordance with the first general compression scheme 110 that is not particular to data formatted in accordance with the markup language. The compressed data 108 is also decompressable in accordance with the second specific compression scheme 112 that is particular to data formatted in accordance with the markup language.

In one embodiment, the compressed markup-language data 108 is generated by compressing previously generated raw, uncompressed markup-language data into the compressed markup-language data 108. For instance, such raw, uncompressed markup-language data may be the data 202 of FIG. 2A or the SAX-event representation 204 of FIG. 2B. The compressed data 108 may be that which includes the data stream 360 of FIG. 3C that has been described. Alternatively, the compressed markup-language data 108 may be generated directly without having to first generate or employ raw, uncompressed markup-language data. For instance, the data stream 360 of FIG. 3C may be directly generated “on the fly,” without having to first generate the data 202 of FIG. 2A or the SAX-event representation 204 of FIG. 2B. The latter embodiment is achieved or performed more quickly than the former embodiment is achieved or performed.

The node 102 transmits the compressed markup-language data 108 (504), either as the data 108 is generated, or once the data 108 has been completely generated as a whole. In either case, the receiving node 104 receives the compressed markup-language data 108 (506). The receiving node 104 then decompresses the compressed markup-language data 108 (508), either “on the fly” as the data 108 is received, or once after all the data 108 has been completely received. Preferably, the receiving node 104 decompresses the compressed data 108 in accordance with the specific scheme 112 as has been described. However, if the specific scheme 112 is not available to the node 104—for instance, where it has not been installed at the node 104—then the node 104 decompresses the compressed data 108 in accordance with the general scheme 110.

In accordance with the general compression scheme 110 (510), the receiving node 104 first decompresses the compressed markup-language data 108 into raw, uncompressed markup-language data (512) in one process. For instance, this raw, uncompressed markup-language data may be the SAX-event representation 204 of FIG. 2B. Thereafter, in a separate process, the receiving node 104 parses the raw, uncompressed markup-language data (514). The receiving node 104 may, for example, automatically begin parsing once the decompression process has signaled that it has finished. Alternatively, a user at the receiving node 104 may initiate the parsing process once he or she recognizes that the decompression process has finished. For instance, the SAX-event representation 204 of FIG. 2B may be parses into the raw, uncompressed markup-language data 202 of FIG. 2A, as has been described.

In accordance with the specific compression scheme 112 (516), the receiving node 104 decompresses and parsing the compressed markup-language data 108 in a single process. Thus, the receiving node 104 does not have to first generate raw, uncompressed markup-language data from the compressed markup-language data. For instance, the node 104 may not have to first generate the SAX-event representation 204 of FIG. 2B and/or the uncompressed markup-language data 202 of FIG. 2A.

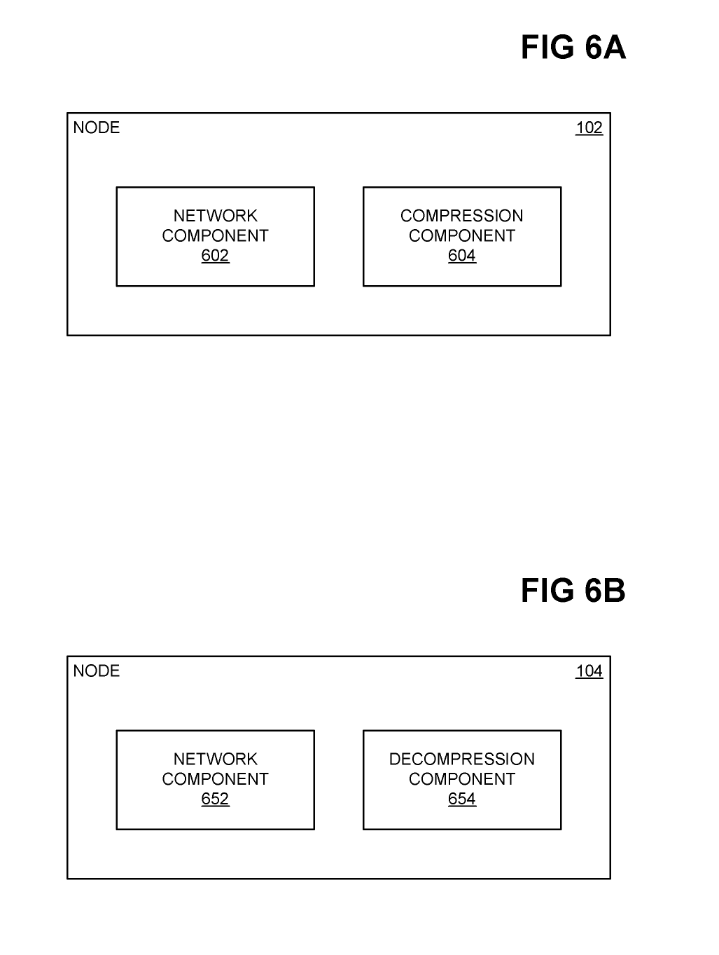

FIG. 6A shows a representative implementation of the transmitting node 102, according to an embodiment of the invention. The node 102 is depicted in FIG. 6A as including a network component 602 and a compression component 604. Each of the components 602 and 604 may be implemented in software, hardware, or a combination of software and hardware. The node 102 may be a computing device, and typically includes other components in addition to those depicted in FIG. 6A, as can be appreciated by those of ordinary skill within the art.

The network component 602 enables the transmitting node 102 to transmit compressed markup-language data over a network, such as the network 106 of FIG. 1. The network component 602 may be or include a network adapter, for instance. By comparison, the compression component 604 enables the transmitting node 102 to generate compressed markup-language data that is decompressable in accordance with both the general compression scheme 110 and the specific compression scheme 112, as has been described.

FIG. 6B shows a representative implementation of the receiving node 104, according to an embodiment of the invention. The node 104 is depicted in FIG. 6B as including a network component 652 and a decompression component 654. Each of the components 652 and 654 may be implemented in software, hardware, or a combination of software and hardware. The node 104 may be a computing device, and typically includes other components in addition to those depicted in FIG. 6B, as can be appreciated by those of ordinary skill within the art.

The network component 652 enables the receiving node 104 to receive compressed markup-language data over a network, such as the network 106 of FIG. 1. The network component 652 may be or include a network adapter, for instance. By comparison, the decompression component 654 enables the receiving node 104 to decompress compressed markup-language data in accordance with either the general compression scheme 110 or the specific compression scheme 112, as has been described.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
at a first node,
generating compressed markup-language data, the compressed markup-language data decompressable in accordance with a first general compression scheme that is not particular to data formatted in accordance with a markup language, and decompressable in accordance with a second specific compression scheme that is particular to data formatted in accordance with the markup language;
transmitting the compressed markup-language data;
at a second node,
receiving the compressed markup-language data; and,
decompressing the compressed markup-language data using one of the first general compression scheme and the second specific compression scheme.

2. The method of claim 1, wherein generating the compressed markup-language data comprises compressing previously generated raw, uncompressed markup-language data into the compressed markup-language data.

3. The method of claim 1, wherein generating the compressed markup-language data comprises directly generating the compressed markup-language data, without having to first generate or employ raw, uncompressed markup-language data.

4. The method of claim 3, wherein directly generating the compressed markup-language data is achieved more quickly than generating raw, uncompressed markup-language data corresponding to the compressed markup-language data.

5. The method of claim 1, wherein decompressing the compressed markup-language data comprises decompressing the compressed markup-language data in accordance with the first general compression scheme that is not particular to data formatted in accordance with the markup language.

6. The method of claim 5, wherein decompressing the compressed markup-language data in accordance with the first general compression scheme comprises decompressing the compressed markup-language data into raw, uncompressed markup-language data.

7. The method of claim 6, further comprising parsing the raw, uncompressed markup-language data in a process separate from decompressing the compressed markup-language data.

8. The method of claim 1, wherein decompressing the compressed markup-language data comprises decompressing the compressed markup-language data in accordance with the second specific compression scheme that is particular to data formatted in accordance with the markup language.

9. The method of claim 8, wherein decompressing the compressed markup-language data in accordance with the second specific compression scheme comprises decompressing and parsing the compressed markup-language data in a single process, without having to first generate raw, uncompressed markup-language data from the compressed markup-language data.

10. The method of claim 1, wherein the markup language is extensible Markup Language (XML), and the first general compression scheme is one of deflate and zip.

11. A computing device comprising:
a network component to transmit compressed markup-language data over a network; and,
a compression component to generate the compressed markup-language data decompressable in accordance with a first general compression scheme that is not particular to data formatted in accordance with a markup language, and decompressable in accordance with a second specific compression scheme that is particular to data formatted in accordance with the markup language.

12. The computing device of claim 11, wherein the compression component is to generate the compressed markup-language data by compressing previously generated raw, uncompressed markup-language data into the compressed markup-language data.

13. The computing device of claim 11, wherein the compression component is to generate the compressed markup-language data by directly generating the compressed markup-language data, without having to first generate or employ raw, uncompressed markup-language data.

14. The computing device of claim 13, wherein the compression component generates the compressed markup-language data more quickly than generating raw, uncompressed markup-language data corresponding to the compressed markup-language data.

15. A computing device comprising:
a network component to receive compressed markup-language data over a network, the compressed markup-language data decompressable in accordance with a first general compression scheme that is not particular to data formatted in accordance with a markup language, and decompressable in accordance with a second specific compression scheme that is particular to data formatted in accordance with the markup language; and,
a decompression component to decompress the compressed markup-language data using one of the first general compression scheme and the second specific compression scheme.

16. The computing device of claim 15, wherein the decompression component is to decompress the compressed markup-language data in accordance with the first general compression scheme that is not particular to data formatted in accordance with the markup language.

17. The computing device of claim 16, wherein the decompression component is to decompress the compressed markup-language data into raw, uncompressed markup-language data.

18. The computing device of claim 17, wherein the decompression component is further to parse the raw, uncompressed markup-language data in a process separate from decompressing the compressed markup-language data.

19. The computing device of claim 15, wherein the decompression component is to decompress the compressed markup-language data in accordance with the second specific compression scheme that is particular to data formatted in accordance with the markup language.

20. The computing device of claim 19, wherein the decompression component is to decompress the compressed markup-language data by decompressing and parsing the compressed markup-language data in a single process, without having to first generate raw, uncompressed markup-language data from the compressed markup-language data.
